(19) United States
(12) Patent Application Publication
(10) Pub. No.: US 2025/0322689 A1
(43) Pub. Date: Oct. 16, 2025

(54) INFORMATION PROCESSING DEVICE, INFORMATION PROCESSING METHOD, AND RECORDING MEDIUM

(71) Applicant: SONY SEMICONDUCTOR SOLUTIONS CORPORATION, KANAGAWA (JP)

(72) Inventors: Akira YOKOKAWA, KANAGAWA (JP); Yoshitaka SUGIMOTO, KANAGAWA (JP); Seiji KURODA, KANAGAWA (JP); Yuichi SUZUKI, KANAGAWA (JP); Masaya KABUTO, KANAGAWA (JP)

(21) Appl. No.: 18/873,519

(22) PCT Filed: Jun. 8, 2023
(86) PCT No.: PCT/JP2023/021289

§ 371 Date: Dec. 10, 2024

(30) Foreign Application Priority Data
Jun. 20, 2022 (JP) 2022-098577

(51) Int. Cl. G06V 40/16; G06V 10/22; G06V 10/44; G06V 40/40

(52) U.S. Cl. CPC G06V 40/161; G06V 10/22; G06V 10/44; G06V 40/172; G06V 40/45

(57) ABSTRACT

The present technique relates to an information processing device, an information processing method, and a recording medium capable of reducing the processing time and the processing load of face detection.

In an image region of a photographed image obtained by an imaging device, a region in which face detection is not to be performed is detected as an excluded region, and a face image is detected from a face detection target region that is a region other than the excluded region in the image region of the photographed image.

### TECHNICAL FIELD

The present technique relates to an information processing device, an information processing method, and a recording medium, and particularly to an information processing device, an information processing method, and a recording medium capable of reducing the processing time and the processing load of face detection.

### BACKGROUND ART

PTL 1 discloses that, after a face image is detected from an image photographed by a camera, an authenticity determination process of determining whether or not the detected face image is an image of a face of a real person is performed.

### CITATION LIST

### Patent Literature

### PTL 1

Japanese Patent Laid-open No. 2014-219703

### SUMMARY

### Technical Problem

In the case where a face of a person is detected from an image photographed by a camera, it is desirable that an image region other than a face of a person actually existing in a photographing place be excluded from a target region of face detection as much as possible and that the processing time and the processing load of the face detection be reduced.

The present technique has been achieved in view of such a situation and enables reduction in the processing time and the processing load of face detection.

### Solution to Problem

An information processing device or a recording medium according to the present technique is an information processing device including a processing unit that detects, as an excluded region, a region in which face detection is not to be performed, in an image region of a photographed image obtained by an imaging device, and that detects a face image from a face detection target region that is a region other than the excluded region in the image region of the photographed image, or a computer-readable recording medium that records a program to cause a computer to function as such an information processing device.

An information processing method according to the present technique is an information processing method of an information processing device having a processing unit, the method including, by the processing unit, detecting, as an excluded region, a region in which face detection is not to be performed, in an image region of a photographed image obtained by an imaging device, and detecting a face image from a face detection target region that is a region other than the excluded region in the image region of the photographed image.

In the information processing device, the information processing method, and the recording medium according to the present technique, a region in which face detection is not to be performed is detected as an excluded region in an image region of a photographed image obtained by an imaging device, and a face image is detected from a face detection target region that is a region other than the excluded region in the image region of the photographed image.

### BRIEF DESCRIPTION OF DRAWINGS

FIG. 1 is a block diagram for depicting a configuration example of a face authentication system according to an embodiment to which the present technique is applied.

FIG. 2 is a diagram for explaining a method of limiting a target region for face detection on a photographed image to a partial region.

FIG. 3 is a configuration diagram for depicting a configuration example of an image processing device.

FIG. 4 is a flowchart for exemplifying a processing procedure performed by the face authentication system.

FIG. 5 is a diagram for exemplifying a case where face detection is performed according to the flowchart of FIG. 4.

FIG. 6 is a diagram for exemplifying the case where face detection is performed according to the flowchart of FIG. 4.

FIG. 7 is a diagram for exemplifying a case where face detection is performed by a well-known method.

FIG. 8 is a block diagram for depicting a configuration example of an embodiment of a computer to which the present technique is applied.

### DESCRIPTION OF EMBODIMENT

Hereinafter, an embodiment of the present technique will be described with reference to the drawings.

### Face Authentication System According to Embodiment

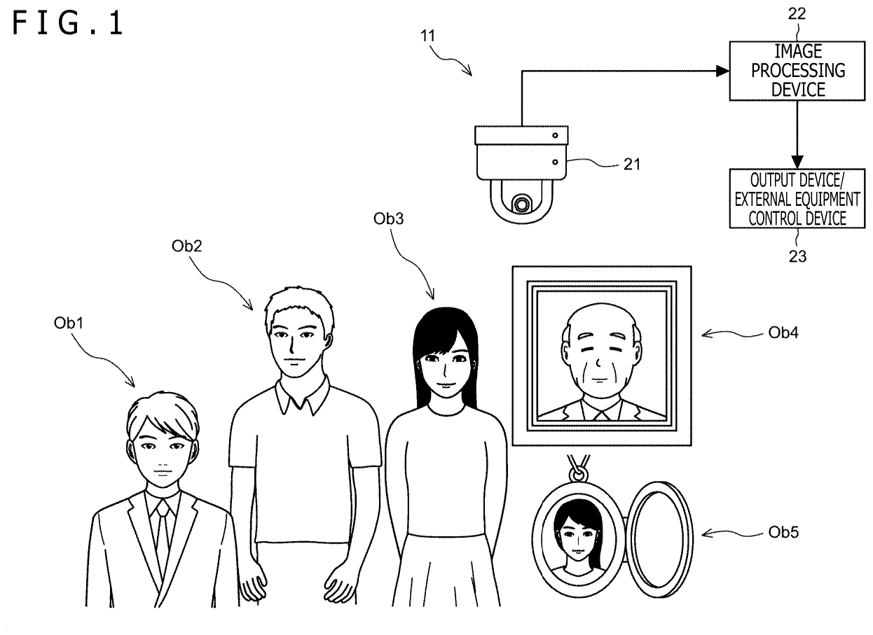

FIG. 1 is a block diagram for depicting a configuration example of a face authentication system according to an embodiment to which the present technique is applied.

In FIG. 1, in a face authentication system 11 according to the present embodiment, for example, an image processing device 22 performs face detection for detecting a face (face image) of a person from a photographed image (video) photographed by a camera 21 (imaging device). The face authentication system 11 collates the face of the person detected from the photographed image (referred to as a detected face) with a face of a person registered in advance (registered person), and in the case where the detected face and the face of the registered person match each other as a result of the collation, the face authentication system 11 supplies the fact that the detected face has been authenticated (face authentication) as the face of the registered person, information of the registered person, and the like to an output device/external equipment control device 23 as authentication result information. The output device/external equipment control device 23 is an example of a device that uses the authentication result, and represents either one of or both an output device and an external equipment control device. For example, the output device is a monitor that displays the authentication result, and the external equipment control device is a control device that controls external equipment according to the authentication result. It should be noted that the face authentication system 11 according to the present embodiment is not used for limited specific applications but can be used for various applications. For example, the face authentication system 11 can be used as a face authentication system that performs face authentication on visitors at an entrance of a facility where security is required, and that opens a gate device to allow only a visitor who has been authenticated as a previously registered person to enter the facility. In this case, the external equipment control device of the output device/external equipment control device 23 corresponds to a control device or the like that controls opening or closing of the gate device. It should be noted that the face image detected on the photographed image is also referred to simply as a face.

In addition, the face authentication system 11 according to the present embodiment distinguishes faces of persons, such as real persons Ob1 to Ob3, existing as real persons in a photographing place (photographing range) of a camera 21 from faces (faces not existing as real persons), such as face photographs Ob4 and Ob5, presented by presentation media (presentation media for presenting images) such as a paper medium and an electronic medium existing in the photographing place, and performs face detection and face authentication only for image regions of the real persons Ob1 to Ob3. Accordingly, the processing time and the processing load required for the face detection in the image processing device 22 can be reduced, and unauthorized face authentication based on a fake face using a presentation medium can be prevented.

The face authentication system 11 has the camera 21, the image processing device 22, and the output device/external equipment control device 23. The camera 21 is installed around the photographing place. However, the camera 21 may be mounted on a mobile object such as a mobile-type robot, and the installation place of the camera 21 is not limited to any specific place. The photographed image photographed by the camera 21 is supplied to the image processing device 22. It should be noted that the photographed image may be a moving image including frames (frame images) photographed at predetermined time intervals or a still image, but it is assumed in the present embodiment that the photographed image is a moving image.

The image processing device 22 detects a face of a person included in the photographed image supplied from the camera 21 and collates it with faces of one or more persons (registered persons) registered in advance. As a result of the collation, in the case where it is determined that the detected face that has been detected matches any of the faces of the registered persons, the image processing device 22 authenticates (face authentication) that the detected face (or the person) is the matched face of the registered person (or the registered person). In the case where it is determined that the detected face does not match any of the faces of the registered persons, the image processing device 22 determines that the detected face is not the face of any registered person, and does not authenticate that the detected face is any of the faces of the registered persons. The authentication result information including the fact that the detected face has been authenticated (face authentication) as the face of a registered person, information of the registered person, and the like is supplied to the output device/external equipment control device 23.

The output device/external equipment control device 23 includes an output device (monitor or the like) that displays the authentication result information supplied from the image processing device 22, and an external equipment control device that controls external equipment according to the authentication result information.

### Method of Limiting Face Detection Target Region in Image Processing Device 22

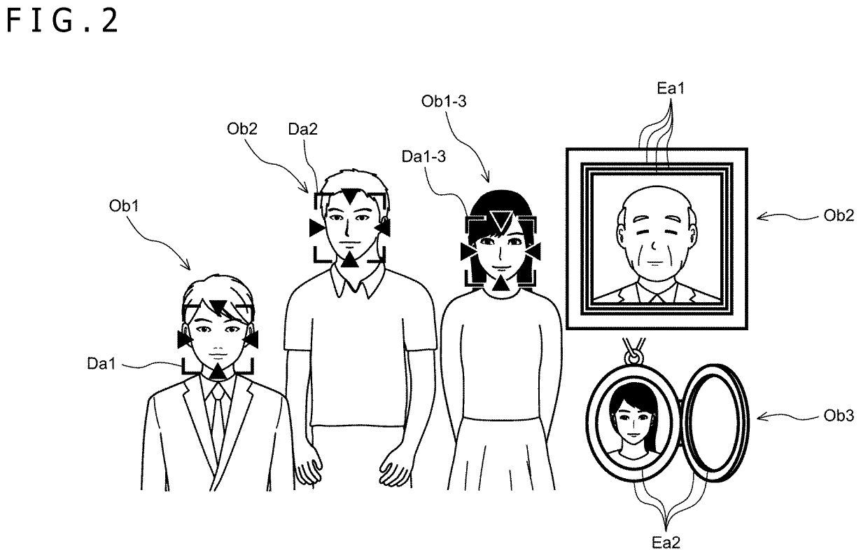

FIG. 2 is a diagram for explaining a method of limiting a target region (face detection target region), in which the face authentication system 11 performs face detection (and face authentication) on a photographed image, to a partial region. In FIG. 2, the real persons Ob1 to Ob3 and face photographs Ob4 and Ob5 same as those in FIG. 1 are exemplified. The image processing device 22 detects, on the photographed image supplied from the camera 21, a geometrically shaped contour line such as a rectangular (square) frame or an elliptical frame that is a feature of a photograph or a support frame of a photograph, and excludes a region surrounded by the contour line from the face detection target region where face detection is to be performed. In this sense, for example, since, around the faces of the real persons Ob1 to Ob3, there are no geometrically shaped contour lines that move within the photographed image along with the faces of the real persons Ob1 to Ob3, face detection is performed for the real persons Ob1 to Ob3, and regions Da1 to Da3 of the respective faces are detected. Meanwhile, geometrically shaped contour lines Ea1 and Ea2 that are features of photographs or support frames of photographs exist around the face photographs Ob4 and Ob5, respectively. The contour line Ea1 is one or more contour lines of a frame supporting the face photograph Ob4, and the contour line Ea2 is one or more contour lines of a photo pendant. As described above, an image presented on a presentation medium such as a paper medium like a face photograph or an electronic medium (a display of a smartphone, a tablet, or the like) has a contour line of the presentation medium itself or a contour line of a support frame supporting the presentation medium, and is surrounded by a geometrically shaped contour line. In addition, in the photographed image, it is considered that a face of a person as a real person is not included in the region surrounded by the geometrically shaped contour line. Hence, even when the region surrounded by the geometrically shaped contour line is excluded from the face detection target region in the photographed image, the region of the face of the person as a real person is not excluded from the face detection target region, and hence, the face detection target region is limited to an appropriate partial region of the photographed image.

### Configuration of Image Processing Device 22

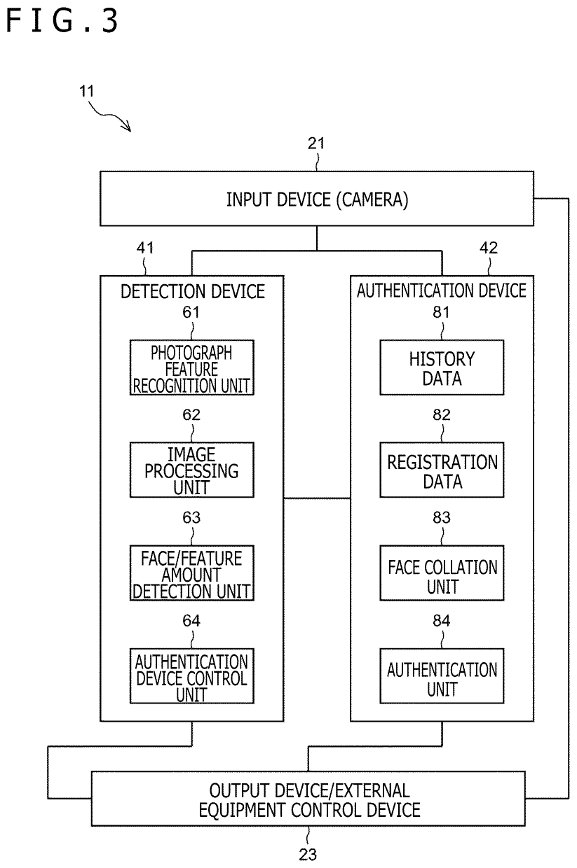

FIG. 3 is a configuration diagram for depicting a configuration example of the image processing device 22. In FIG. 3, the face authentication system 11, the camera 21, and the output device/external equipment control device 23 are same as the parts denoted by the same reference signs in FIG. 1, and hence, the description thereof is omitted. A detection device 41 and an authentication device 42 are included in the image processing device 22 of FIG. 1. The detection device 41 limits the face detection target region on the photographed image supplied from the camera 21 and performs face detection on the image of the face detection target region. The authentication device 42 performs face authentication using the faces of the registered persons on a detected face detected by the detection device 41. It should be noted that the image processing device 22 can be configured using what is generally called a computer including a processor, a memory, and the like, and the configuration of FIG. 3 can be realized by execution of software including a program.

The detection device 41 has a photograph feature recognition unit 61, an image processing unit 62, a face/feature amount detection unit 63, and an authentication device control unit 64. The photograph feature recognition unit 61 recognizes, on a photographed image supplied from the camera 21, a region having a feature of a photograph. As described above, the feature of the photograph includes a region surrounded by a contour line of a photograph or a support frame supporting a photograph, that is, by a simple geometrically shaped contour line such as a straight line or an ellipse. It is assumed that such a region is regarded as an excluded region that is excluded from the face detection target region. Even if the excluded region is an image region that does not actually include a photograph, it is considered that the excluded region is a region that does not include a face of a person as a real person either, and hence, it may be excluded from the face detection target region. In addition, the excluded region is not limited to a region having a feature of a photograph and includes a region of any kind of presentation medium having a feature similar to that of the photograph. In addition, in the configuration example of FIG. 3, the photograph feature recognition unit 61 detects a region having a feature of a photograph and sets the detected region as an excluded region, but may instead detect a region having a feature of a presentation medium and set the detected region as an excluded region. It should be noted that the excluded region is detected before face detection is performed, and is excluded from the face detection target region. Thus, the excluded region is detected as a region in which face detection is not to be performed regardless of whether or not a silhouette image presented by a presentation medium such as a face photograph is actually included, and is detected also as a region in which a face image of a person as a real person is not included (a region with a high possibility that a face image of a person as a real person is not included).

The photograph feature recognition unit 61 performs the following detections 1 and 2 on the photographed image supplied from the camera 21, and detects, as an excluded region, a region surrounded by a contour line of a photograph or a support frame supporting a photograph, that is, a region having a feature of a photograph. It should be noted that the following detections by the photograph feature recognition unit 61 can be applied not only as the detection of a region having a feature of a photograph but also as the detection of a region (region having a feature as an excluded region) in which a face image of a person as a real person is not included.
Detection 1, line segment detection (Line Segment Detector)

The photograph feature recognition unit 61 detects a line segment from within the photographed image by use of a well-known Line Segment Detector method, and detects a region surrounded by continuous line segments as an excluded region. Even in the case where a region is not completely surrounded by continuous line segments, a part of a contour line of a photograph that is merely missing in the photographed image but actually exists may be estimated from line segments forming other contour lines.
Detection 2, region detection (Box Detection, Segmentation, Hough transform, Edge contour)

The photograph feature recognition unit 61 detects, as an excluded region, a region surrounded by a contour line having a rectangular, elliptical, or polygonal shape existing in the photographed image, by use of a well-known detection method such as Box Detection, Segmentation, Hough transform, or Edge contour.

It should be noted that, since there is a case where a line segment or the like is detected as the background of the photographed image, the photograph feature recognition unit 61 may acquire in advance line segments constantly existing in the photographed image or regions surrounded by a contour line having a rectangular, elliptical, or polygonal shape, and may prevent them from being recognized as a contour line of an excluded region or as an excluded region.

In addition, as a method (as a detection 3) of detecting a region having a feature of a photograph, the photograph feature recognition unit 61 may detect an excluded region having a feature of a photograph by spatial detection. Specifically, the photograph feature recognition unit 61 uses a distance sensor to acquire distance information regarding a spatial region including the photographing range of the camera 21. The photograph feature recognition unit 61 acquires in advance (before operation or the like) a planar region that constantly exists in the photographing range of the camera 21, on the basis of the distance information, and in the case where a planar region that does not constantly exist is detected on the basis of the distance information, a region in the photographed image corresponding to that planar region is set as an excluded region. In addition, the photograph feature recognition unit 61 uses optical information detection means such as a polarization sensor to acquire optical features (a light source, a direction of reflection, and the like) of a spatial region including the photographing range of the camera 21 as optical feature information. The photograph feature recognition unit 61 acquires optical feature information regarding the photographing range of the camera 21 in advance (before operation or the like) or by another information processing device, and in the case where optical feature information that does not exist in the photographed image or that is different from that of another spatial region is detected, a region in the photographed image corresponding to that region is set as an excluded region.

In addition, in the processes of the detections 1 to 3, any one or multiple processes may be performed. In addition, the processes of the detections 1 to 3 may be performed using a learning model having a neural network structure generated by using a machine learning technique.

The image processing unit 62 generates, for the photographed image supplied from the camera 21, an image of the face detection target region in which the image of the excluded region detected by the photograph feature recognition unit 61 has been removed. The face/feature amount detection unit 63 detects an image or a feature amount of a face from the image of the face detection target region generated by the image processing unit 62, by use of a well-known method. The authentication device control unit 64 supplies the image or the feature amount of the detected face detected by the face/feature amount detection unit 63 to the authentication device 42, and causes the authentication device 42 to perform face authentication.

The authentication device 42 has history data 81, registration data 82, a face collation unit 83, and an authentication unit 84. It should be noted that the authentication device 42 is an example of a device that uses the image or the feature amount of the detected face detected by the detection device 41, and the present technique is not limited to the case where face authentication is performed.

The history data 81 includes information regarding a registered person authenticated by the authentication unit 84 as being the same person with respect to the image or the feature amount of the detected face detected by the face/feature amount detection unit 63 of the detection device 41, from the past to the present, information such as the time of the authentication, and the like.

The registration data 82 is information regarding a person registered in advance and includes identification information (name or the like) for identifying the person and a face image of each person (face of each registered person). It should be noted that, instead of the face image, information regarding the feature amount extracted from the face image may be registered in the registration data 82.

The face collation unit 83 collates the detected face with the faces of the registered persons registered in the registration data 82, on the basis of the image or the feature amount of the detected face detected by the face/feature amount detection unit 63 of the detection device 41.

As a result of the collation by the face collation unit 83, it is determined whether or not the detected face matches any of the faces of the registered persons, and in the case where they match each other, the authentication unit 84 authenticates that the detected face (or the person) is the matched face of the registered person (or the registered person). In the case where it is determined that the detected face does not match any of the faces of the registered persons, the authentication unit 84 determines that the detected face (or the person) is not the face of the registered person (or the registered person), and does not authenticate that the detected face is any of the faces of the registered persons (or any of the registered persons). The authentication result information regarding the result of the face authentication, such as the fact that the face has been authenticated and information regarding the registered person whose face has been authenticated, is supplied to the output device/external equipment control device 23.

### Processing Procedure of Face Authentication System 11

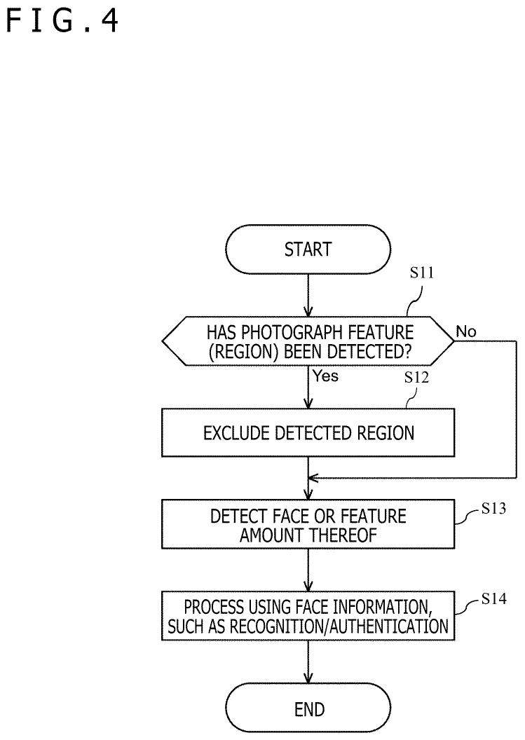

FIG. 4 is a flowchart for exemplifying a processing procedure performed by the face authentication system 11. In Step S11, the photograph feature recognition unit 61 of the detection device 41 determines whether or not a region having a feature of a photograph has been detected in the photographed image supplied from the camera 21. It should be noted that, as described above, the region having a feature of a photograph may be regarded as a region having a feature of a presentation medium. In the case where the determination is positive in Step S11, the detected region is defined as an excluded region, and the process proceeds from Step S11 to Step S12. In the case where the determination is negative in Step S11, the process proceeds from Step S11 to Step S13.

In Step S12, the image processing unit 62 of the detection device 41 generates, as an image of the face detection target region, an image obtained by removing the image of the excluded region detected in Step S11 from the photographed image supplied from the camera 21. The process proceeds from Step S12 to Step S13. It should be noted that, in the case where the determination is negative in Step S11, the entire photographed image supplied from the camera 21 is set as the image of the face detection target region.

In Step S13, the face/feature amount detection unit 63 of the detection device 41 detects an image or a feature amount of a face from the image of the face detection target region generated in Step S12 or from the image of the face detection target region in the case where the determination is negative in Step S11. The process proceeds from Step S13 to Step S14. In Step S14, the authentication device 42 performs a process such as authentication or recognition by collation with faces of registered persons, by using the image of the face or the feature amount of the face detected in Step S13. The process returns from Step S14 to Step S11, and Step S11 to Step S14 are repeated.

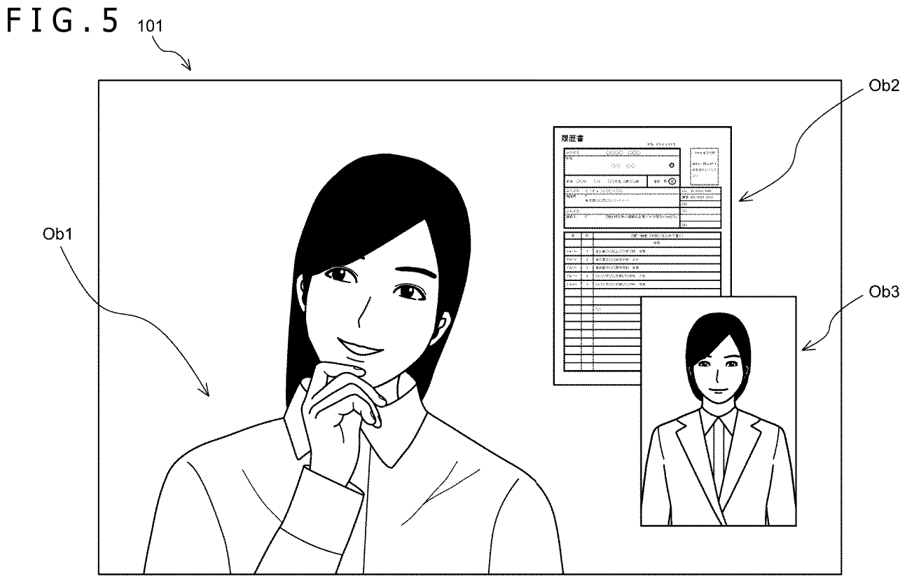

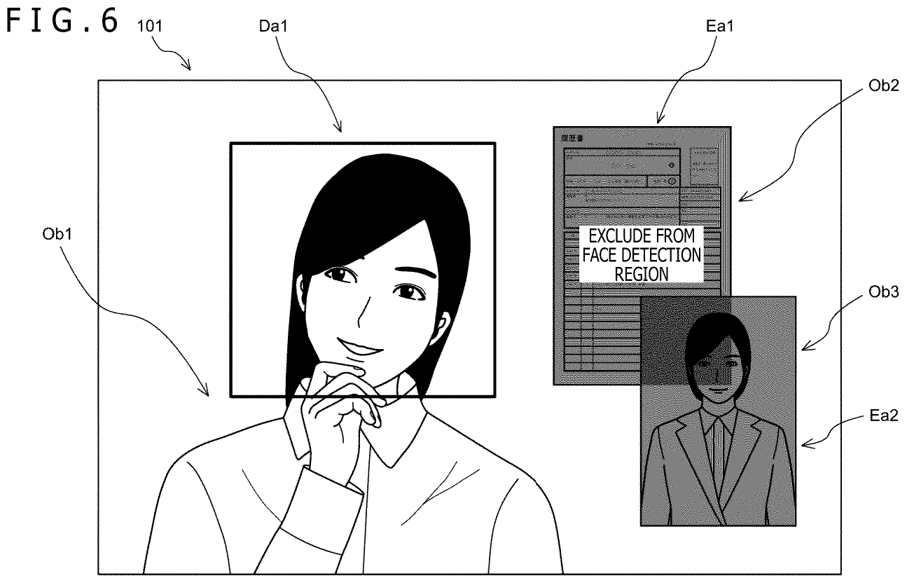

FIG. 5 and FIG. 6 are diagrams each exemplifying a case where face detection is performed according to the flowchart of FIG. 4. In FIG. 5, it is assumed that a real person Ob1, a sheet of paper Ob2, and a face photograph (photograph in which a face appears) Ob3 are reflected in a photographed image 101 supplied from the camera 21. For such a photographed image 101, as depicted in FIG. 6, a region surrounded by a contour line Ea1 having a rectangular (square) shape of the sheet of paper Ob2 and a region surrounded by a contour line Ea2 having a rectangular shape of the face photograph Ob3 are detected as excluded regions in Step S11. As a result, in Step S13, a face (or a feature amount thereof) is detected from within the image of the face detection target region obtained by removing the images of the excluded regions from the photographed image 101, and thus, only a region Da1 of the face image of the real person Ob1 is detected.

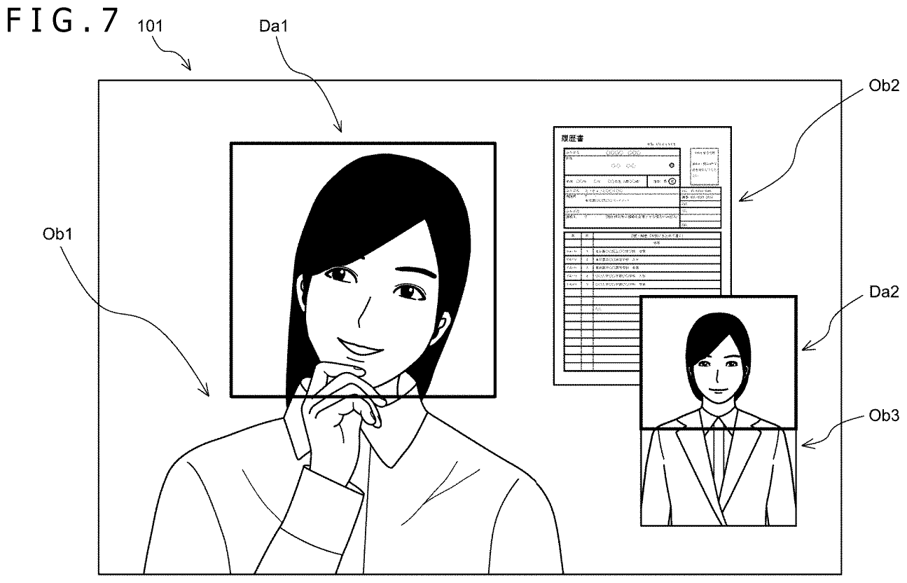

FIG. 7 is a diagram for exemplifying a case where face detection is performed by a well-known method. It should be noted that, in the drawing, parts corresponding to those in FIG. 5 and FIG. 6 are denoted by the same reference signs, and the description thereof is omitted. In FIG. 7, since the detection of an excluded region is not conventionally performed, face detection is performed on the entire photographed image 101. As a result, not only the region Da1 of the face image of the real person Ob1 but also a region Da2 of the face image of the face photograph Ob3 is detected. Accordingly, the processing time and the processing load required for face detection that would originally be unnecessary increase, and there is also a possibility that unauthorized face authentication is performed using a fake photograph that is not the real person in question.

Here, the present technique is compared with the technique described in PTL 1 (Japanese Patent Laid-open No. 2014-219703). In the face authentication system or the like, there is a case where it is necessary to determine the authenticity of a detected face. In PTL 1, a face image is detected from a photographed image within a photographing range of a camera, and the following authenticity determination processes are performed on the detected face region.
Rectangular estimation based on a rectangular frame or a line segment in a certain range around the face
The rate of change in the background around the face as well as the continuity of the background
Whether face parts and the like change in a certain period of time
Determination using biometric authentication (additional HW/algorithm)

Since these authenticity determination processes are performed for each detected face region, in the case where a face authentication system, such as a walk-through type, in which a large number of faces exist in a photographed image is assumed, the processing load becomes heavy according to the number of detected faces, and a problem that the processing time exceeds an expected processing time may arise.

On the other hand, in the present technique, a region in which a face of a person as a real person does not exist is excluded as an excluded region from the face detection target region in the photographed image, and face detection and face authentication for that excluded region are not performed, so that the processing time and the processing load of the face detection can be reduced. Accordingly, the present technique can detect a large number of faces as compared with the well-known technique such as PTL 1.

### Configuration Example of Computer

The series of processes described above can be executed by hardware or software. In the case where the series of processes is executed by software, a program configuring the software is installed in a computer. Here, the computer includes a computer incorporated in dedicated hardware, a general-purpose personal computer capable of executing various functions by installing various programs, and the like, for example.

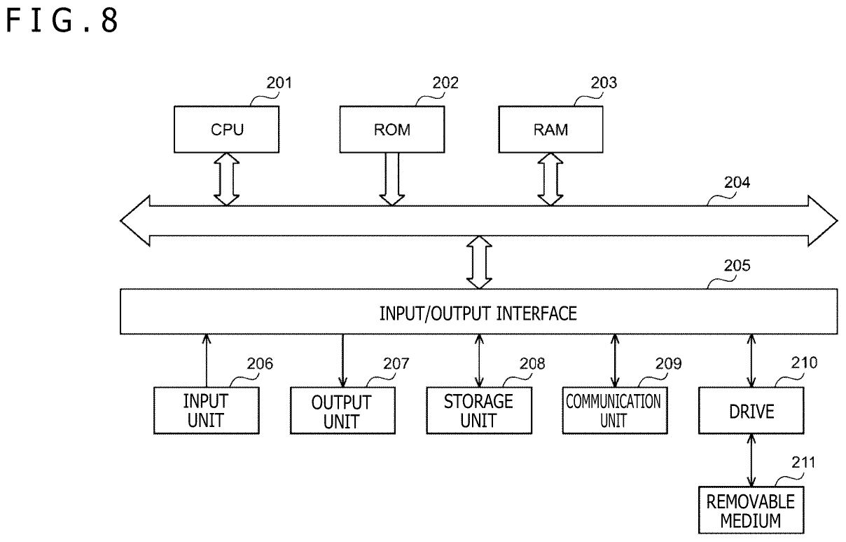

FIG. 8 is a block diagram for depicting a configuration example of hardware of a computer for executing the series of processes described above by a program.

In the computer, a CPU (Central Processing Unit) 201, a ROM (Read Only Memory) 202, and a RAM (Random Access Memory) 203 are connected to each other via a bus 204.

An input/output interface 205 is further connected to the bus 204. An input unit 206, an output unit 207, a storage unit 208, a communication unit 209, and a drive 210 are connected to the input/output interface 205.

The input unit 206 includes a keyboard, a mouse, a microphone, and the like. The output unit 207 includes a display, a speaker, and the like. The storage unit 208 includes a hard disk, a nonvolatile memory, and the like. The communication unit 209 includes a network interface and the like. The drive 210 drives a removable medium 211 such as a magnetic disk, an optical disk, a magneto-optical disk, or a semiconductor memory.

In the computer configured as described above, for example, the CPU 201 loads a program stored in the storage unit 208 into the RAM 203 via the input/output interface 205 and the bus 204 and executes the program, so that the series of processes described above is performed.

The program executed by the computer (CPU 201) can be recorded in, for example, the removable medium 211 as a package medium or the like to be provided. In addition, the program can be provided via a wired or wireless transmission medium such as a local area network, the Internet, or digital satellite broadcasting.

In the computer, the program can be installed in the storage unit 208 via the input/output interface 205 by the removable medium 211 being loaded to the drive 210. In addition, the program can be received by the communication unit 209 via a wired or wireless transmission medium and installed in the storage unit 208. Alternatively, the program can be installed in the ROM 202 or the storage unit 208 in advance.

It should be noted that the program executed by the computer may be a program that performs processes in time series along the order described in the present specification, or a program that performs processes in parallel or at a necessary timing such as when a call is made.

Here, in the present specification, the processes performed by the computer according to the program need not necessarily be performed in time series along the order described as a flowchart. That is, the processes performed by the computer according to the program include processes executed in parallel or individually (for example, parallel processing or processes by objects).

In addition, the program may be processed by one computer (processor) or processed by multiple computers in a distributed manner. Further, the program may be transferred to a remote computer for execution.

Further, in the present specification, the system means a collection of multiple constitutional elements (devices, modules (parts), and the like), and it does not matter whether or not all of the constitutional elements are in the same housing. Therefore, both multiple devices housed in separate housings and connected to each other via a network and one device having multiple modules housed in one housing are systems.

In addition, for example, the configuration described as one device (or processing unit) may be divided and configured as multiple devices (or processing units). Conversely, the configurations described above as multiple devices (or processing units) may be collectively configured as one device (or processing unit). In addition, it is obvious that a configuration other than those described above may be added to the configuration of each device (or each processing unit). Further, if the configuration and operation as the entire system are substantially the same, a part of the configuration of a certain device (or processing unit) may be included in the configuration of another device (or another processing unit).

In addition, for example, the present technique can adopt a configuration of cloud computing in which one function is shared by multiple devices via a network and jointly processed.

In addition, for example, the program described above can be executed in any device. In this case, it is sufficient that the device has necessary functions (functional blocks or the like) and is capable of obtaining necessary information.

In addition, for example, each of the steps described in the above-described flowchart can be executed by one device or by multiple devices in a shared manner. Further, in the case where multiple processes are included in one step, the multiple processes included in the one step can be executed by one device or by multiple devices in a shared manner. In other words, the multiple processes included in one step can also be executed as processes of multiple steps. Conversely, the processes described as multiple steps can be collectively executed as one step.

It should be noted that, regarding the program executed by the computer, processes of steps describing the program may be executed in time series along the order described in the present specification, or may be executed in parallel or individually executed at a necessary timing such as when a call is made. That is, as long as no inconsistency occurs, the processes of steps may be executed in an order different from that described above. Further, the processes of steps describing the program may be executed in parallel with processes of another program, or may be executed in combination with processes of another program.

It should be noted that the multiple aspects of the present technique described in the present specification can be carried out independently and individually as long as no inconsistency occurs. It is obvious that any multiple aspects of the present technique may be carried out in conjunction with each other. For example, some or all of aspects of the present technique described in any embodiment may be carried out in combination with some or all of aspects of the present technique described in another embodiment. In addition, some or all of aspects of the present technique described above can be carried out in conjunction with another technique that is not described above.

It should be noted that the present technique can also take the following configurations.
(1)

An information processing device including:
a processing unit that detects, as an excluded region, a region in which face detection is not to be performed, in an image region of a photographed image obtained by an imaging device, and that detects a face image from a face detection target region that is a region other than the excluded region in the image region of the photographed image.
(2)

The information processing device according to (1) above,
in which the processing unit detects, as the excluded region, a region in which a face image of a person as a real person is not included, in the image region of the photographed image.
(3)

The information processing device according to (1) or (2) above,
in which the processing unit detects, as the excluded region, a region having a feature of a photograph.
(4)

The information processing device according to any of (1) through (3) above,
in which the processing unit detects, as the excluded region, a region having a feature of a presentation medium for presenting an image.
(5)

The information processing device according to (3) above,
in which the presentation medium includes a paper medium.
(6)

The information processing device according to (3) or (4) above,
in which the presentation medium includes an electronic medium.
(7)

The information processing device according to any of (1) through (6) above,
in which the processing unit detects, as the excluded region, a region surrounded by a geometrically shaped contour line.
(8)

The information processing device according to (7) above,
in which the contour line has continuous line segments.
(9)

The information processing device according to (7) or (8) above,
in which the contour line has a rectangular, elliptical, or polygonal shape.
(10)

The information processing device according to any of (1) through (9) above,
in which the processing unit detects, as the excluded region, a region in the photographed image corresponding to a planar region existing in a space.
(11)

The information processing device according to any of (1) through (10) above,
in which the processing unit detects, as the excluded region, a region in the photographed image corresponding to a region in which an optical feature in a space is different from those of other regions.
(12)

The information processing device according to any of (1) through (11) above, including:
an authentication unit that performs face authentication on the basis of the face image detected by the processing unit and a face image of a registered person registered in advance.
(13)

An information processing method of an information processing device having a processing unit, the method including:
by the processing unit, detecting, as an excluded region, a region in which face detection is not to be performed, in an image region of a photographed image obtained by an imaging device, and detecting a face image from a face detection target region that is a region other than the excluded region in the image region of the photographed image.
(14)

A computer-readable recording medium that records a program to cause a computer to function as
a processing unit that detects, as an excluded region, a region in which face detection is not to be performed, in an image region of a photographed image obtained by an imaging device, and that detects a face image from a face detection target region that is a region other than the excluded region in the image region of the photographed image.

It should be noted that the present embodiment is not limited to the above-described embodiment, and various changes can be made without departing from the gist of the present disclosure. In addition, the effects described in the present specification are exemplary and not limitative, and other effects may be presented.

### REFERENCE SIGNS LIST

11: Face recognition system
21: Camera
22: Image processing device
23: Output device/external equipment control device
41: Detection device
42: Recognition device
61: Photograph feature recognition unit
62: Image processing unit
63: Face/feature amount detection unit
64: Authentication device control unit
83: Face collation unit
84: Authentication unit

What is claimed is:

1. An information processing device comprising:
a processing unit that detects, as an excluded region, a region in which face detection is not to be performed, in an image region of a photographed image obtained by an imaging device, and that detects a face image from a face detection target region that is a region other than the excluded region in the image region of the photographed image.

2. The information processing device according to claim 1,
wherein the processing unit detects, as the excluded region, a region in which a face image of a person as a real person is not included, in the image region of the photographed image.

3. The information processing device according to claim 1,
wherein the processing unit detects, as the excluded region, a region having a feature of a photograph.

4. The information processing device according to claim 1,
wherein the processing unit detects, as the excluded region, a region having a feature of a presentation medium for presenting an image.

5. The information processing device according to claim 4,
wherein the presentation medium includes a paper medium.

6. The information processing device according to claim 4,
wherein the presentation medium includes an electronic medium.

7. The information processing device according to claim 1,
wherein the processing unit detects, as the excluded region, a region surrounded by a geometrically shaped contour line.

8. The information processing device according to claim 7,
wherein the contour line has continuous line segments.

9. The information processing device according to claim 7,
wherein the contour line has a rectangular, elliptical, or polygonal shape.

10. The information processing device according to claim 1,
wherein the processing unit detects, as the excluded region, a region in the photographed image corresponding to a planar region existing in a space.

11. The information processing device according to claim 1,
wherein the processing unit detects, as the excluded region, a region in the photographed image corresponding to a region in which an optical feature in a space is different from those of other regions.

12. The information processing device according to claim 1, comprising:
an authentication unit that performs face authentication on a basis of the face image detected by the processing unit and a face image of a registered person registered in advance.

13. An information processing method of an information processing device having a processing unit, the method comprising:
by the processing unit, detecting, as an excluded region, a region in which face detection is not to be performed, in an image region of a photographed image obtained by an imaging device, and detecting a face image from a face detection target region that is a region other than the excluded region in the image region of the photographed image.

14. A computer-readable recording medium that records a program to cause a computer to function as
a processing unit that detects, as an excluded region, a region in which face detection is not to be performed, in an image region of a photographed image obtained by an imaging device, and that detects a face image from a face detection target region that is a region other than the excluded region in the image region of the photographed image.
